(19) United States
(12) Patent Application Publication
(10) Pub. No.: US 2012/0083181 A1
(43) Pub. Date: Apr. 5, 2012

(54) FLYING DISC WITH PRINTABLE LAMINATE SURFACING

(76) Inventor: Mike Holgate, Asheville, NC (US)

(21) Appl. No.: 12/896,317

(22) Filed: Oct. 1, 2010

(51) Int. Cl. A63H 27/00; B32B 37/12; B32B 38/14; B32B 37/16

(52) U.S. Cl. 446/46; 156/242

(57) ABSTRACT

A flying disc for use in recreational activities and sports, such as for catch and throw, disc golf, and the like, is provided. The flying disc includes a disc body, the disc body including a circular central flight deck section and an annular rim connected thereto, and a laminate layer having a printable outer surface, the laminate layer bonded to and extending over at least a portion of the central flight deck section, wherein the central flight deck section optionally includes non-planar surfaces. The printable outer surface of the laminate layer has a predetermined roughness, and the disc body has a predetermined roughness greater than the predetermined roughness of the printable outer surface of the laminate layer, thereby providing improved aerodynamic features such as disc speed and lift.

### BACKGROUND

The present invention relates to a flying disc and, more particularly, to a flying disc with a printable laminate surfacing.

Disc golf is a game that is typically played on courses laid out in parks or other recreational areas. A course consists of a number of “holes”, such as nine or eighteen, with each hole having a ‘tee box’ from which a disc is originally thrown by each player and a target ‘hole’ positioned at a selected distance from the tee.

In playing disc golf, a disc is thrown from a tee box in a direction of the respective hole. After the throw, the player picks up the disc at its point of progression, and again throws the disc towards the target. This process is continued until the disc is captured within the target, completing the hole. After all the holes are played, the number of throws required to complete each hole is added to provide a total score.

Prior attempts to incorporate decorative designs or indicia on the exposed convex and upper surface of a flying disc have involved placing decorative effects on this disc surface, either with painting, or by the application of a suitable decal or decals. As an example of the difficulties in incorporating decorative effects onto discs, U.S. Pat. No. 4,351,129 to Kerkenbush et al points to a method disclosed in U.S. Pat. No. 4,204,357 to Harrington of attaching a circular insert of a plastic material such as polyester to an annular flying disc. U.S. Pat. No. 4,204,357 to Harrington shows an annular disc having a plurality of projections molded near its inner perimeter. An insert with a plurality of holes adjacent to its perimeter fits over the disc and associated projections. The projections are heated and flattened out to hold the insert to the disc. Harrington also teaches the application of an adhesive tape over the heads of the projections to further hold the insert in place. According to U.S. Pat. No. 4,351,129 to Kerkenbush et al, this method suffers several deficiencies for the attachment of a polyester insert. Without some positive means of attachment, the insert will detach from the disc, either by elastic deformation of the flattened projections or by deformation of the holes in the insert. The adhesive tape alone is ineffective to hold the insert to the disc. According to U.S. Pat. No. 4,351,129 to Kerkenbush et al, because of the diverse composition of polyester and a thermoplastic such as polyethylene, of which such discs are usually constructed, the polyester cannot be fusion bonded to a thermoplastic disc with any degree of success. The polyester may slowly detach from the annular section of the disc, impairing the disc's aerodynamic integrity, or may separate completely, defeating the purpose of the device and detracting from its aesthetic appeal. U.S. Pat. No. 4,204,357 to Harrington discloses a method of bonding polyester to polyethylene using a flame to specially prepare the surface for a critically defined time period. A special adhesive must be applied to the surfaces to be bonded and allowed to cure before the surfaces are joined.

Thus, there is a need for improvement with respect to flying discs and the approaches for providing acceptable decorative effects or indicia on such discs. While it is desirable to achieve clear sharp images or patterns in bright distinctive colors, it would also be desirable to achieve clear sharp images or patterns in bright distinctive colors while, at the same time, expanding the range of materials suitable for forming such flying discs.

### SUMMARY

The present invention provides a method for forming a flying disc that has acceptable decorative effects or indicia. Moreover, the method according to the present invention permits flying discs to be manufactured that have clear sharp images or patterns in bright distinctive colors while, at the same time, making possible an expansion of the range of materials suitable for forming such flying discs.

According to one aspect of the present invention, a method of making a flying disc is provided, the method comprising molding a plastic material to form a disc body. The disc body includes a circular central flight deck section having a top surface and a bottom surface and an annular rim circumscribing and integral with the central flight deck section. The method also includes printing indicia on a printable outer surface of a planar laminate layer and bonding the planar laminate layer to at least a portion of the top surface of the flight deck section of the disc body. Another aspect comprises applying an additional adhesive material between at least a portion of the laminate layer and at least a portion of the top surface of the flight deck section.

According to another aspect of the present invention, a method of making a flying disc is provided and the method includes making a flying disc by molding a plastic material to form a disc body. The disc body includes a circular central flight deck section having a top surface and a bottom surface, a plurality of contoured features, wherein each of the contoured features defines a cavity within the top surface of the flight deck section, and an annular rim circumscribing and integral with the central flight deck section. It also includes printing indicia on a printable outer surface of a planar laminate layer and bonding the planar laminate layer to at least a portion of the top surface of the flight deck section of the disc body.

According to a further aspect of the present invention, a flying disc is provided that is made by molding a plastic material to form a disc body, the disc body including a circular central flight deck section having a top surface and a bottom surface and an annular rim circumscribing and integral with the central flight deck section, printing indicia on a printable outer surface of a planar laminate layer, and bonding the planar laminate layer to at least a portion of the top surface of the flight deck section of the disc body. In accordance with a further feature of this aspect of the present invention, the flying disc can be made by applying an additional adhesive material between at least a portion of the laminate layer and at least a portion of the top surface of the flight deck section prior to the bonding step.

### BRIEF DESCRIPTION OF THE DRAWINGS

For a more complete understanding of the embodiments of the present invention, reference is now made to the following descriptions taken in connection with the accompanying drawings in which:

FIG. 1 is a side view of a flying disc in accordance with an embodiment of the invention;

FIG. 2 is a top view of the flying disc of FIG. 1;

FIG. 3 is a bottom view of the flying disc of FIG. 1;

FIG. 4 is a side view of a flying disc in accordance with another embodiment of the invention;

FIG. 5 is a top view of the flying disc of FIG. 4;

FIG. 6 is a bottom view of the flying disc of FIG. 4;

FIG. 7 is a top view of a laminate layer with a printable outer surface, the laminate layer being a layer that can be comprised in a flying disc;

FIG. 8 is a side view of the laminate layer of FIG. 7;

FIG. 9 is a perspective view of a printer performing a printing operation on the printable outer surface of the laminate layer of FIG. 7; and

FIGS. 10A, 10B, and 10C schematically illustrate the steps performed in bonding the laminate layer of FIG. 7 to a disc body to produce cured versions of the flying discs shown in FIGS. 1 and 4.

### DETAILED DESCRIPTION OF AN EMBODIMENT

The present invention will now be described more fully hereinafter with reference to the accompanying drawings in which exemplary embodiments of the invention are shown. However, this invention may be embodied in many different forms and should not be construed as limited to the embodiments set forth herein. These exemplary embodiments are provided so that this disclosure will be both thorough and complete, and will fully convey the scope of the invention to those skilled in the art. Like reference numbers refer to like elements throughout the various drawings.

It may be noted that in the description herein, a disc may be described and/or claimed by terms such as “top”, “bottom”, “beneath”, “downward”, “upward”, “inner”, “outer”, “central”, or the like, for the purpose of facilitating description of the disc structure. These terms are intended as relative terms to describe relative directions about the disc structure as though the disc being described were observed in a horizontal, upright orientation as illustrated in the side views herein. In other words, the disc may be described relative to a conventional coordinate system (polar or ordinate) which is centered on the disc. As a further clarification, the term “inner” means radially toward the center of the disc and “outer” means radially away from the center of the disc.

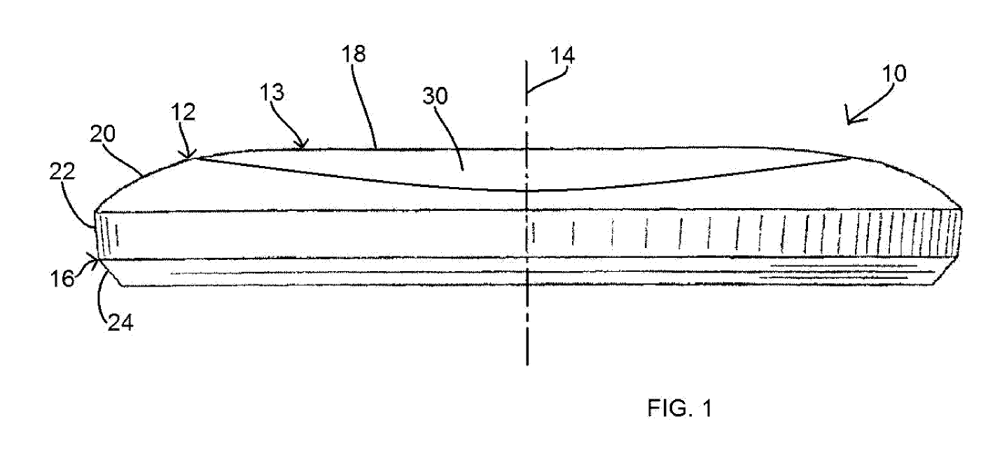

Referring now to the drawings, and particularly FIGS. 1-3, an embodiment of a flying disc 10 is illustrated.

The flying disc 10 comprises a disc body that is integrally molded from flexible plastic material. Not to be construed as limiting, the disc typically has a mass of about 120 gm-130 gm for recreational catch-style and a mass up to about 200 gm for a golf style disc, with about 60% of the mass contained in the rim. Nevertheless, weight and weight distribution for the disc may be modified by the disc designer. It should also be noted that the flying disc 10 may be configured with a characteristic or characteristics to comply with a regulation promulgated by an organization involved in the flying disc sport or play events. For example, one organization involved in the flying disc sport or play events—the Professional Disc Golf Association (PDGA)—has, with respect to approved discs, specified an upper weight range in terms of a maximum weight to diameter ratio.

The disc 10 has a disc body 12 on which a laminate layer having printed indicia is installed. The disc body 12 includes a circular flight deck section 13 extending from a central axis 14 to an annular outer rim 16. The flight deck section 13 is comprised of a central section 18 and a transition section 20 connecting the deck section 13 to the outer rim 16.

The central section 18 typically is planar with uniform thickness, but may be non-planar, such as convex (i.e. domed) or concave, and the thickness may vary along a selected dimension or dimensions such as, for example, increasing from the central axis 14 to the transition section 20. It is preferred that the center section 18 be sufficiently thin and flexible so that the disc 10 will resiliently bend upon impact in order to absorb energy and minimize potential damage to the disc 10. It should also be noted that flexibility standards for golf discs have been promulgated by the Professional Disc Golf Association.

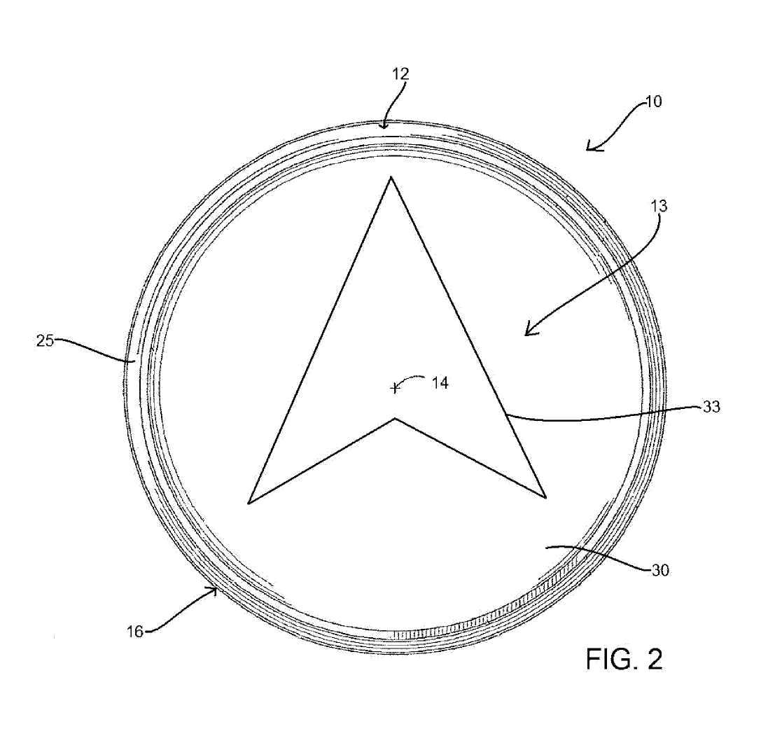

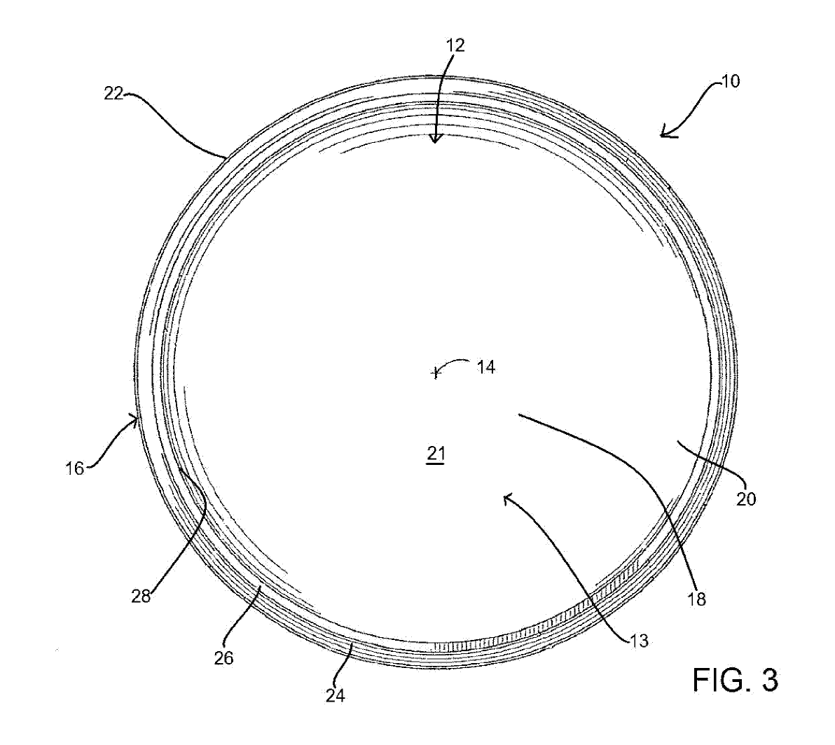

The rim 16 extends downwardly from the transition section 20 and delimits a central hollow 21 beneath the flight deck section 13. The rim 16 has an outer edge 22, a shoulder 24, and an inner rim surface 28 that defines, in a radial sense, the outer boundary of the central hollow 21 (FIG. 3). The disc body 12 has an upward facing top surface 25 (FIG. 2A and a downward facing bottom surface 26 (FIG. 3).

The rim 16, being somewhat blunt in configuration, is suitable for accurate short to medium length throws, such as those made during “putting” in disc golf. As will be appreciated by those skilled in the art of flying disc engineering, other rim configurations may be used in order to provide desired aerodynamics and, hence, the flying disc of the present invention is not to be construed as being limited to any particular rim configuration. For example, a rim may be sharply angled in order to cut through the air with less drag, which is a configuration often more suitable for long throws, such as those desired during “driving” in disc golf.

The disc body 12 has a first predetermined surface roughness, where roughness is a measure of texture of a surface, quantified by outward deviations of a surface from its ideal form. When the deviations are large, the surface has a higher roughness than when the deviations are small.

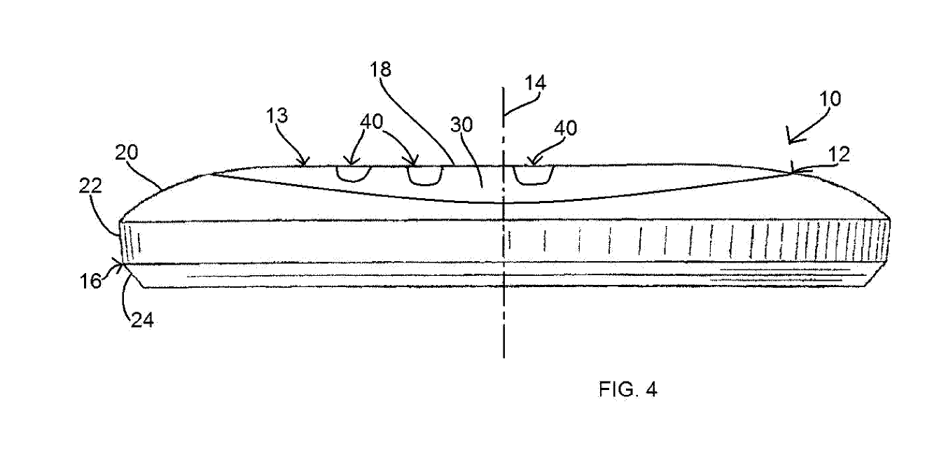

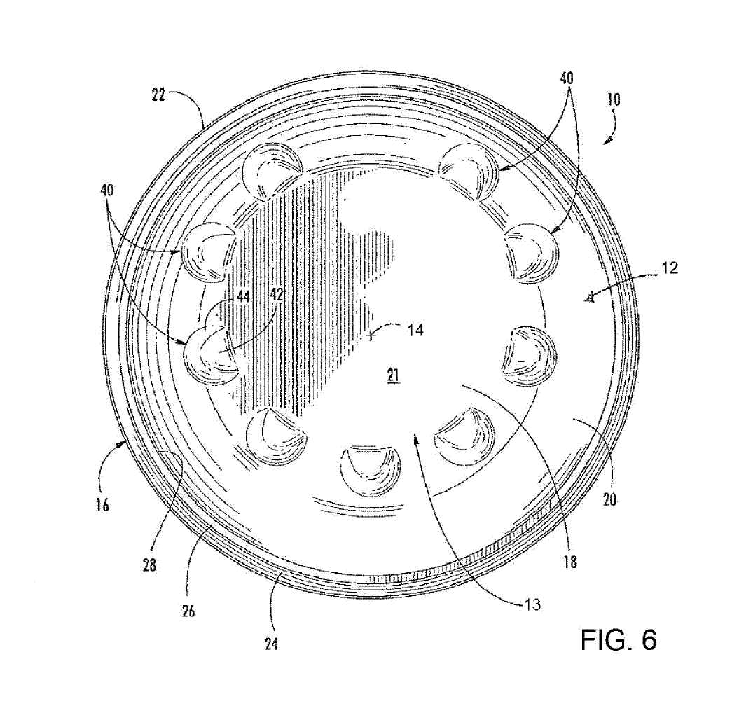

Referring now to FIGS. 4-6, another embodiment of the flying disc of the present invention is illustrated that comprises contoured features 40 formed in the flight deck section 13 of the flying disc 10 for providing desired flight performance characteristics. Each contoured feature 40 defines a cavity in the flight deck section 13. Each contoured feature 40 also defines a protrusion extending from the bottom surface of the deck section 13 (FIG. 6). That is, the contoured features 40 extend beneath the curvilinear plane defined by the flight deck section 13 and the cavities also extend beneath the flight deck plane. It is noted that the contoured features 40 may include a raised portion, or lip, that extends above the flight deck section 13. The contoured features 40 improve flight stability by creating a Coanda effect.

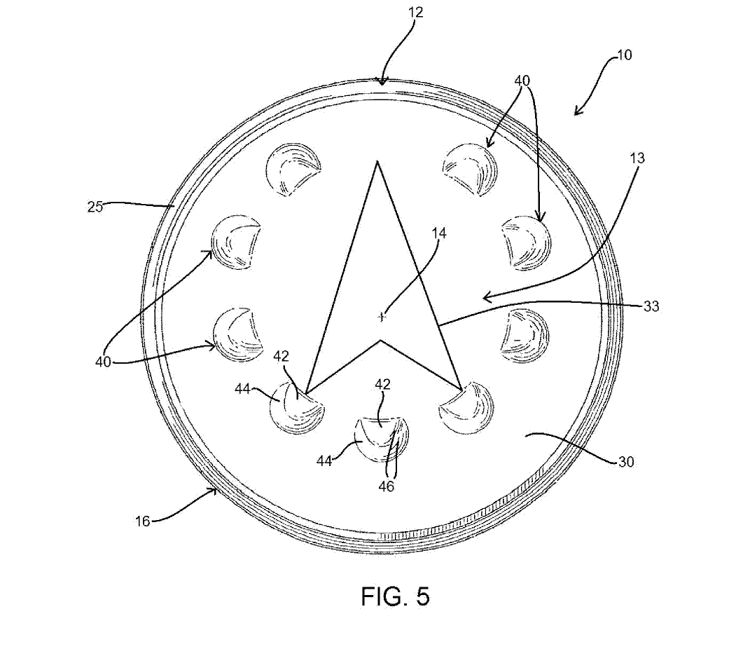

The contoured features 40 may optionally include a U-shaped downwardly angled first section 42 and a C-shaped upwardly angled second section 44. The contoured features 40 may also have ridges or indentations (reference is had to gripping rings 46 shown in FIG. 5 as an example of a contoured feature) but generally the contoured features 40 are smooth. The illustrated size and shape of the contoured features 40 are exemplary and may be modified by the disc designer. That is, the contoured features 40 may have any shape or size, as desired, and the contoured features 40 may be provided in any variety of flying disc.

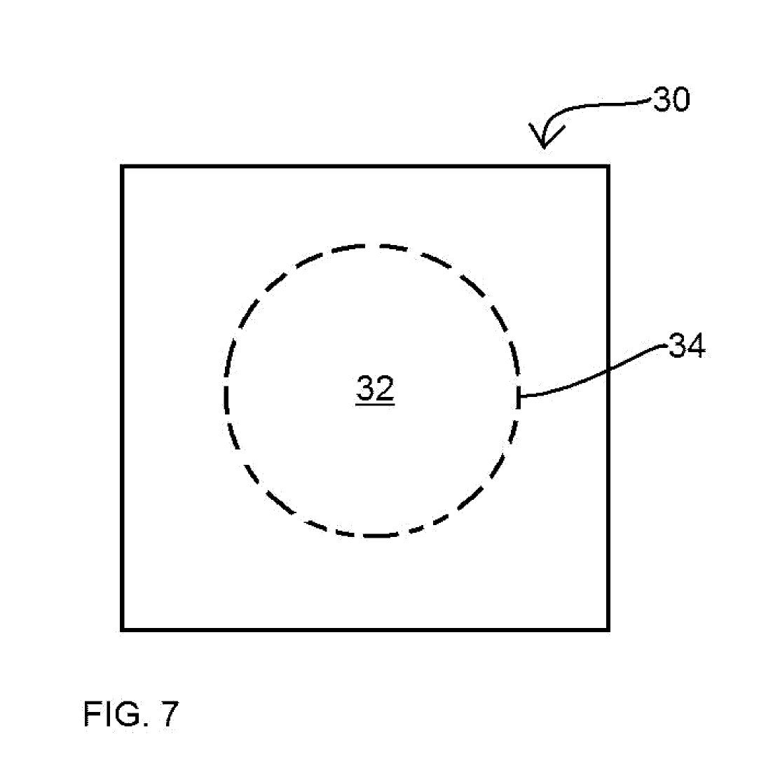

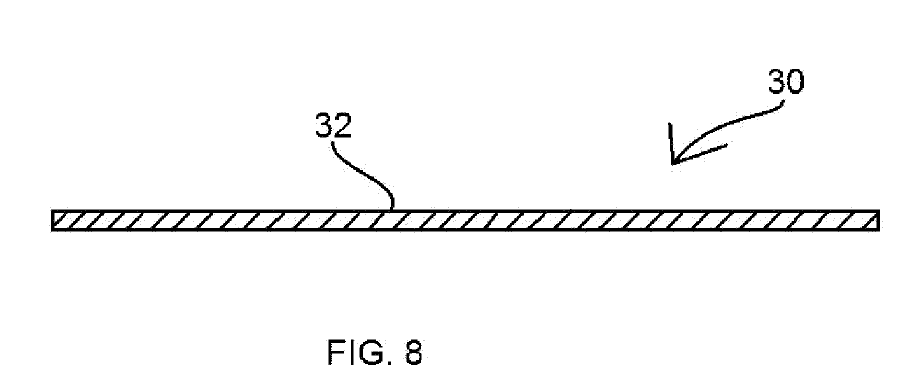

With reference now to FIGS. 7 and 8, a planar laminate layer 30 is illustrated that can be comprised in the one embodiment of the disc 10 shown in FIGS. 1-3 or in the embodiment of the disc 10 shown in FIGS. 4-6. The laminate layer 30 is bonded to the top surface 25 of the disc body 12 to form the flying disc 10. The laminate layer 30 has a printable outer surface 32 onto which any sort of indicia 33, such as graphics or text, (see FIGS. 2 and 5) may be printed. The laminate layer 30 is preferably comprised of a waterproof plastic material film that bonds readily and firmly with toners, inks, adhesives, and laminating films, and can be used in various printing processes such as offset, flexo, thermal transfer, laser, and ink jet. By virtue of the fact that the laminate layer 30 has the printable outer surface 32, printing and bonding is facilitated over prior art alternatives such as one known printing approach that involves printing on a printable material, sandwiching the printable material between two outer layers, bonding the outer layers to the printable material, and finally bonding one outer layer to another surface (such as a disc body).

The laminate layer 30 is preferably also dimensionally stable, microporous, and durable, with a high lamination peel strength. The laminate layer 30 may optionally be utilized in the form of a sheet (FIG. 7) or a roll (not shown). Not to be construed as limiting, the laminate layer 30 preferably has a thickness of about 6 to 18 mils. An example product that includes these attributes and which could be utilized for the laminate layer 30 has been commercially available under the trademark “Teslin”. Optionally, the laminate layer 30 may include a perforated area 34 to facilitate extraction of a predetermined portion of the laminate layer 30.

The laminate layer 30 may be provided with a second predetermined surface roughness that is less than the first predetermined roughness of the disc body 12. With the disc body 12 having a predetermined roughness greater than the predetermined roughness of the laminate layer 30, aerodynamic features such as disc speed and lift are improved. That is, the top of the flying disc 10 becomes more smooth with the bonded laminate layer 30 as compared to without the laminate layer 30 and therefore the top surface 25 of the disc body 12. Additionally, with the disc body 12 having more of a matte-type finish, even with the improved aerodynamic features of the smoother bonded laminate layer 30, the bottom surface 26, the annular rim 16, and an intermediate zone between the laminate layer 30 and the annular rim 16 all have the first predetermined roughness of the disc body 12, and therefore provide a more grippable surface than does the smoother laminate layer 30.

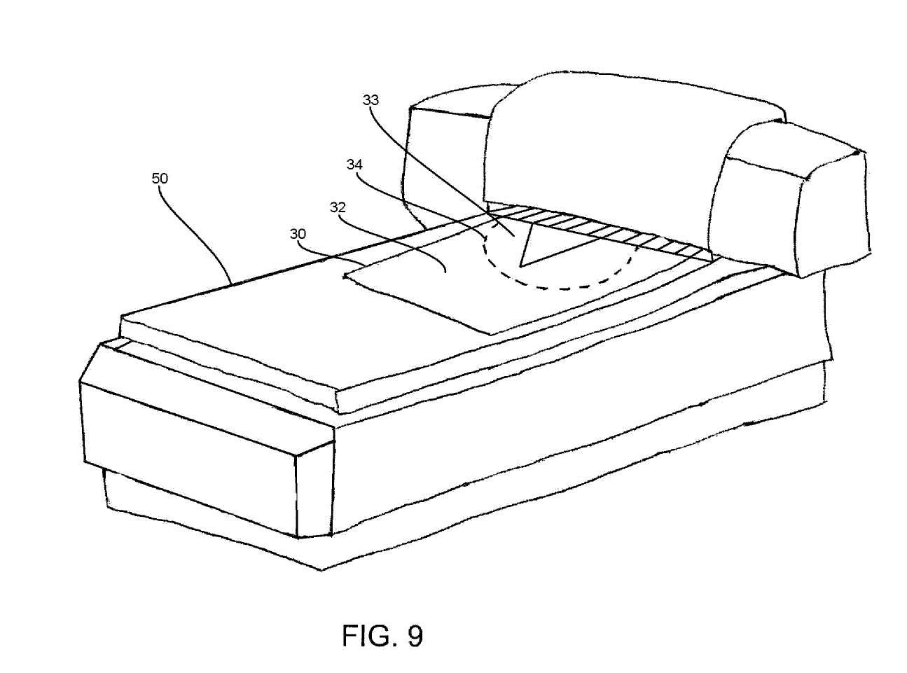

With reference now to FIG. 9, an embodiment of a printer 50 for printing indicia 33 on the printable outer surface 32 of the laminate layer 30 is illustrated. As will be appreciated by those skilled in the art of printing, there are a variety of printing methods for bonding ink, toner, or dye to the printable outer surface 32 of the laminate layer 30—for example, not to be construed as limiting: inkjet, laser, offset, flexo, and thermal transfer. The laminate layer 30 can be fed into the printer 50 in sheet form or as a roll. Printer 50 is illustrated as a flat bed printer, but is not to be construed as limiting, as the printer 50 could alternatively take other forms. Advantageously, the printer 50 is not required to be a specialized or industrial-type printer, and can be a commercially available inexpensive general purpose printer as is often used in a home.

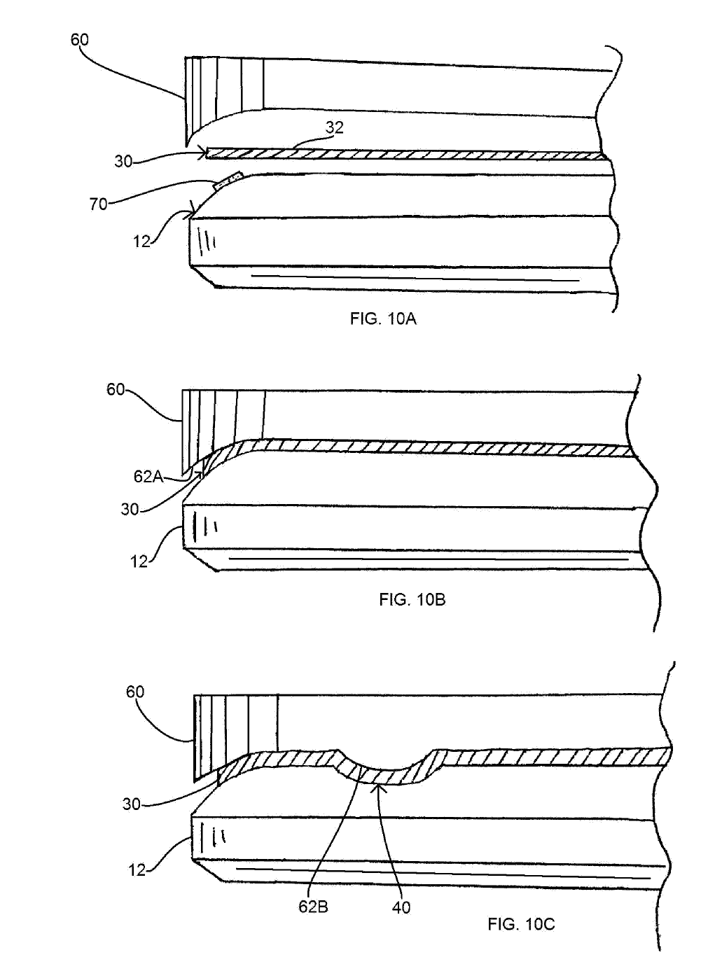

Referring to FIGS. 10A, 10B, and 10C, the steps that are performed bonding the laminate layer 30 the disc body 12 to produce the final flying disc 10 are schematically illustrated. A fixture or jig 60 is pressed down against the laminate layer 30 to mold the laminate layer 30 and bond the laminate layer 30 with the disc body 12. The fixture 60 may include shaped features 62 (FIGS. 10B and 10C) wherein the contours of the shaped features 62 can be paired with the contours of the top surface 25 of the flight deck section 13 of the disc body 12 so that the laminate layer 30 is brought into smooth conformance with the irregular surfaces of the disc body 12, such as the transition section 20 and contoured features 40. As will be appreciated by those skilled in the art of bonding laminate layers to body surfaces, there are several alternative methods to secure the disc body 12 in place while the fixture 60 presses the laminate layer 30 into smooth conformance with the disc body 12, such as, not to be construed as limiting, securing the disc body 12 with a clamp (not shown) or resting the disc body 12 on a base (not shown). Optionally, an additional adhesive material 70 may be applied between at least a portion of the top surface 25 of the flight deck section 13 of the disc body 12 and the laminate layer 30 prior to bonding the laminate layer 30 to the disc body 12. Additional adhesive material 70 (FIG. 6A) can, for example, be applied along the edges of the laminate layer 30 or into the contoured features 40 prior to bonding the laminate layer 30 to the disc body 12. The additional adhesive material 70 can be applied to provide additional adhesion at areas of bonding that can be more susceptible to lifting and wear.

As will be appreciated by those skilled in the art of lamination, the laminate layer 30 may be bonded to the disc body 12 through a variety of methods. One example is to sufficiently heat the laminate layer 30 so as to bond the laminate layer 30 to the disc body 12 without distortion of the indicia 33 or of the underlying plastic of the disc body 12. Another solution is to bond the laminate layer 30 to the disc body 12 inside molds used during a plastic injection molding process. An additional example is to bond the laminate layer 30 to the disc body 12 after an injection molding process has molded the disc body 12, and the disc body 12 has been removed from the molds but before the disc body 12 has cooled to ambient surroundings temperature. These examples are not to be construed as limiting, as other embodiments and examples may perform similar functions and/or achieve similar results.

A suitable approach for making the flying disc 10 is to mold a plastic material to form the disc body 12, print the indicia 33 on the printable outer surface 32 of the planar laminate layer 30, and bond the laminate layer 30 to at least a portion of the top surface of the flight deck section 13 of the disc body 12. Optionally, the additional adhesive material 70 may be applied between at least a portion of the laminate layer 30 and at least a portion of the top surface 25 of the flight deck section 13. In a preferred embodiment, when the top surface 25 of the flight deck section 13 is non-planar, bonding the planar laminate layer 30 to at least a portion of the top surface 25 of the flight deck section 13 of the disc body 12 comprises molding the laminate layer 30 to conform to the non-planar top surface 25 of the flight deck section 13.

Alternatively, printing indicia 33 on the printable outer surface 32 of the laminate layer 30 is performed after bonding the laminate layer 30 to at least a portion of the top surface 25 of the flight deck section 13 of the disc body 12. As will be appreciated by those skilled in the art of printing, the printer 50 can be, for example, a flat bed printer with a sufficiently high clearance so as to allow for printing on the laminate layer 30 of the flying disc 10. However, printing on the planar laminate layer 30 and then molding and bonding the laminate layer 30 to the disc body 12 is preferred, particularly when the top surface 25 is non-planar, for example, curved (non-planar) or comprising contoured features 40.

Flying discs intended for use in so-called “disc golf” activities have been subjected to a certification process by the Professional Disc Golf Association (PDGA) to be deemed acceptable for disc golf competitions. The PDGA standards dictate flexibility of certifiable discs and, while some types of plastic such as polypropylene (or polypropene) are relatively very smooth and therefore provide improved aerodynamic features, these types of plastic lack the required flexibility to be approved by the PDGA. Thermoplastic elastomers (TPE) or thermal plastic olefins (TPO) are plastic materials that are known to have sufficient flexibility to meet the PDGA standards, and are relatively less expensive than some higher grade plastic materials such as thermoplastic polyurethanes (TPU). Embodiments of the present invention can be used to advantageously produce a certifiable disc golf disc with sufficient flexibility and with a smoother top surface for improved aerodynamic features. The flying disc 10 produced by embodiments disclosed herein can advantageously be comprised of one or more of various grades of plastic materials, and not just of relatively more expensive plastic materials, because the laminated layer 30 as disclosed can be molded and bonded to a wide range of different grades of plastic material, such as, for example, polypropylene (PP), low-density polyethylene (LDPE), and thermoplastic elastomer (TPE).

The teachings of this application are not to be construed as being limited to any particular flying disc. While various embodiments of the invention have been described and illustrated herein, it is to be distinctly understood that the invention is not limited thereto, but may be otherwise variously embodied and practiced within the scope of the following claims.

What is claimed is:

1. A method of making a flying disc, the method comprising:
molding a plastic material to form a disc body, the disc body including a circular central flight deck section having a top surface and a bottom surface and an annular rim circumscribing and integral with the central flight deck section;
printing indicia on a printable outer surface of a planar laminate layer; and
bonding the planar laminate layer to at least a portion of the top surface of the flight deck section of the disc body.

2. The method according to claim 1 and further comprising applying an additional adhesive material between at least a portion of the laminate layer and at least a portion of the top surface of the flight deck section.

3. The method according to claim 1, wherein the top surface of the flight deck section is non-planar, and wherein bonding the planar laminate layer to at least a portion of the top surface of the flight deck section of the disc body comprises molding the laminate layer to conform to the non-planar top surface of the flight deck section.

4. The method according to claim 1, wherein printing indicia on the printable outer surface of the laminate layer is performed after bonding the laminate layer to at least a portion of the top surface of the flight deck section of the disc body.

5. The method according to claim 1, wherein the printable outer surface of the laminate layer has a predetermined roughness, and the bottom surface of the flight deck section has a predetermined roughness greater than the predetermined roughness of the printable outer surface of the laminate layer.

6. The method according to claim 1, wherein molding a plastic material to form a disc body includes molding a plastic material to form a disc body having a plurality of contoured features, wherein each of the contoured features defines a cavity within the top surface of the flight deck section.

7. The method according to claim 6, wherein bonding the planar laminate layer to at least a portion of the top surface of the flight deck section of the disc body comprises molding the laminate layer to conform to at least one of the contoured features of the flight deck section.

8. The method according to claim 7 and further comprising applying an additional adhesive material between at least a portion of the laminate layer and at least a portion of the at least one of the contoured features of the flight deck section.

9. A flying disc made by a process comprising the steps of:
molding a plastic material to form a disc body, the disc body including a circular central flight deck section having a top surface and a bottom surface and an annular rim circumscribing and integral with the central flight deck section;
printing indicia on a printable outer surface of a planar laminate layer; and
bonding the planar laminate layer to at least a portion of the top surface of the flight deck section of the disc body.

10. The flying disc according to claim 9 and further comprising applying an additional adhesive material between at least a portion of the laminate layer and at least a portion of the top surface of the flight deck section prior to the bonding step.

11. The flying disc according to claim 9, wherein the top surface of the flight deck section is non-planar, and wherein bonding the planar laminate layer to at least a portion of the top surface of the flight deck section of the disc body comprises molding the laminate layer to conform to the non-planar top surface of the flight deck section.

12. The flying disc according to claim 9, wherein the printing step is performed after bonding the laminate layer to at least a portion of the top surface of the flight deck section of the disc body.

13. The flying disc according to claim 9, wherein molding a plastic material to form a disc body includes molding a plastic material to form a disc body to include a plurality of contoured features, wherein each of the contoured features defines a cavity within the top surface of the flight deck section, and bonding the planar laminate layer to at least a portion of the top surface of the flight deck section of the disc body includes molding the laminate layer to conform to at least one of the contoured features of the flight deck section.

14. The flying disc according to claim 13 and further comprising applying an additional adhesive material between at least a portion of the laminate layer and at least a portion of the at least one of the contoured features of the flight deck section prior to the bonding step.

15. The flying disc according to claim 9, wherein printing indicia on a printable outer surface of a planar laminate layer includes printing indicia on a printable outer surface of a planar laminate layer having a predetermined roughness less than the predetermined roughness of the bottom surface of the flight deck section.

16. The flying disc according to claim 15, wherein molding a plastic material to form a disc body includes molding a plastic material to form a disc body having an annular rim that has a predetermined roughness substantially the same as the predetermined roughness of the bottom surface of the flight deck section.

17. The flying disc according to claim 15, wherein molding a plastic material to form a disc body includes molding a plastic material to form a disc body having an annular rim and a laminate layer radially separated from one another by an intermediate zone and the intermediate zone has a predetermined roughness substantially the same as the predetermined roughness of the bottom surface of the flight deck section.

18. A flying disc comprising:
a disc body, the disc body including a circular central flight deck section having a top surface and a bottom surface and an annular rim circumscribing and integral with the central flight deck section; and
a laminate layer having a printable outer surface, the laminate layer extending over at least a portion of the central flight deck section and the printable outer surface of the laminate layer having a predetermined roughness, the bottom surface of the flight deck section having a predetermined roughness greater than the predetermined roughness of the printable outer surface of the laminate layer.

19. The flying disc according to claim 18, wherein the annular rim has a predetermined roughness substantially the same as the predetermined roughness of the bottom surface of the flight deck section.

20. The flying disc according to claim 18, wherein the laminate layer and the annular rim are radially separated from one another by an intermediate zone and the intermediate zone has a predetermined roughness substantially the same as the predetermined roughness of the bottom surface of the flight deck section.
